(19) United States
(12) Patent Application Publication
(10) Pub. No.: US 2011/0292590 A1
(43) Pub. Date: Dec. 1, 2011

(54) MOUNTING ELEMENT FOR AN EXPANSION CARD AS WELL AS CORRESPONDING ARRANGEMENT OF A MOUNTING ELEMENT WITH AN EXPANSION CARD IN A COMPUTER SYSTEM

(75) Inventors: Ralf-Peter Fietz, Paderborn (DE); Ronny Hesse, Bad Lippspringe (DE)

(73) Assignee: Fujitsu Technology Solutions Intellectual Property GmbH, Munchen (DE)

(21) Appl. No.: 13/155,676

(22) Filed: Jun. 8, 2011

Related U.S. Application Data
(63) Continuation of application No. PCT/EP2009/065973, filed on Nov. 27, 2009.

(30) Foreign Application Priority Data
Dec. 8, 2008 (DE) 102008061031.3

(51) Int. Cl. G06F 1/16

(52) U.S. Cl. 361/679.32

(57) ABSTRACT

A mounting element for an expansion card in a computer system includes a bracket-like construction and at least two retaining arms that at least partially encompass an expansion card held in the mounting element, wherein the mounting element can be locked on a retaining element of a module carrier, and the mounting element has a first mount designed to fix an expansion card held in the mounting element substantially perpendicular to the retaining arms such that the mounting element is connected captively to the expansion card.

### RELATED APPLICATIONS

This is a continuation of International Application No. PCT/EP2009/065973, with an international filing date of Nov. 27, 2009 (WO 2010/076102, published Jul. 8, 2010), which is based on German Patent Application No. 102008061031.3, filed Dec. 8, 2008, the subject matter of which is incorporated by reference.

### TECHNICAL FIELD

This disclosure relates to a mounting element for an expansion card in a computer system, wherein the mounting element has a bracket-like construction and at least two retaining arms that at least partially encompass an expansion card held in the mounting element, and wherein the mounting element can be locked on a retaining element of a module carrier.

The disclosure further relates to an arrangement with a mounting element and an expansion card, as well as their arrangement on a module carrier of a computer system.

### BACKGROUND

Computer systems are being realized in flatter and flatter designs. In particular, in blade server systems, narrow expansion cards, so-called “riser” cards, are used that make possible a space-saving expansion of the server systems with daughter cards or so-called “mezzanine” cards. Expansion cards are usually arranged perpendicular to a main circuit board, in particular, a motherboard, in the server, wherein the expansion cards can be connected electrically with a plug to contacts on the motherboard. An expansion card thus acts as a kind of “elbow” or “angle piece” so that a daughter card can be inserted onto the expansion card, wherein the daughter card is arranged parallel to the motherboard.

Expansion cards are often preassembled in server systems, wherein the cards are fixed by mounting elements, for example, bolts and screws, on a chassis or module carrier and connected electrically to a motherboard with plug contacts. This solution is indeed simple and economical, but does not allow tool-less assembly. In addition, mechanical tension or tensional forces between a mounted expansion card and the motherboard can occur if the expansion card cannot be positioned exactly, for example, due to manufacturing tolerances of the module carrier. This makes a secure electrical connection between the expansion card and the motherboard difficult or, under some circumstances, makes a connection impossible.

Furthermore, an installation of expansion cards is often troublesome, because fixing with the mounting elements and making electrical contacts with the motherboard must be performed in several assembly steps. To establish the plug connection between the expansion card and the motherboard, pressure must also be exerted on the back side of the expansion card, wherein there is the risk of damaging solder pins arranged on the back side of the expansion card.

From each of publications DE 298 22 914 U1, U.S. Pat. No. 6,056,579 A, U.S. Pat. No. 2004/0034997 A1, as well as US 2007/0076399 A1, fixing holders for a CPU carrier are known to be able to fix a CPU card in a socket on the CPU carrier. The CPU card is placed at a right angle into the socket and makes electrical contact. Then, the CPU card is fixed by lowering the fixing holder onto the CPU card or connecting it to the CPU card and locking it onto the CPU carrier. Only CPU cards of a uniform structural size can be inserted. Such mounting systems are less practical for expansion cards of the type named above.

It could therefore be helpful to provide a mounting element for an expansion card in a computer system, wherein the mounting element makes possible improved fixing and contacting, as well as simpler handling of an expansion card for its assembly and disassembly.

It could also be helpful to provide a corresponding arrangement of a mounting element with an expansion card, as well as their arrangement on a module carrier of a computer system, which make possible improved fixing and contacting of the expansion card.

### SUMMARY

We provide a mounting element for an expansion card in a computer system including a bracket-like construction and at least two retaining arms that at least partially encompass an expansion card held in the mounting element, wherein the mounting element can be locked on a retaining element of a module carrier, and the mounting element has a first mount designed to fix an expansion card held in the mounting element substantially perpendicular to the retaining arms such that the mounting element is connected captively to the expansion card.

### BRIEF DESCRIPTION OF THE DRAWINGS

FIG. 1 shows a mounting element.

FIG. 2 shows the mounting element according to FIG. 1 with an expansion card locked therein.

FIG. 3 shows a perspective view of a part of a module carrier.

FIG. 4 shows a perspective view of a part of a module carrier with a mounted circuit board.

FIG. 5 shows a perspective view of an arrangement comprising an expansion card, a mounting element, a part of a module carrier and a part of a motherboard.

### LIST OF REFERENCE SYMBOLS

1 Mounting element

2 First mounting means

3 Second mounting means

4 Retaining arms

5 Expansion plate

6 Plug

7 Module carrier

8 Retaining element

9 Circuit board

10 Fixing device

11 Opening

12 Contacts

16 Guide tabs

18 Guide element

### DETAILED DESCRIPTION

We provide a mounting element of the type that has first mounting means that fix an expansion card held in the mounting element on the mounting element such that the mounting element is connected captively to the expansion card. The first mounting means are designed to fix an expansion card held in the mounting element substantially perpendicular to the retaining arms on the mounting element.

This has the advantage that, in such a mounting element, an expansion card can be locked so that a module that is simple to handle is produced. The expansion card is encompassed at least partially in a bracket-like manner by the mounting element so that the module can be gripped by a user without problems and can be easily locked onto a module carrier.

Preferably, the first mounting means are constructed as grooves into which the expansion card can be fixed. An expansion card can be inserted from the front or from the top into the mounting element. It is possible to provide protection from the expansion card sliding out of the grooves, wherein geometrical elements of the plug are used, for example, centering pins or board locks or solder pins between which ribs can be inserted.

Furthermore, we provide an arrangement comprising a corresponding mounting element and an expansion card, wherein the expansion card has a plug for interacting with contacts on a circuit board, wherein the plug is arranged substantially perpendicular to a circuit board of the expansion card and wherein the expansion card is encompassed in a bracket-like manner by the mounting element on the side facing away from the plug and is fixed on the mounting element. Thus, the back side of the mounting element forms a kind of protective cap so that the solder pins formed on the side facing away from the electrical plug contacts of the expansion card are reliably protected from damage.

Thus, the expansion card can be fixed and electrically contacted on a module carrier without additional tools in one assembly step, wherein a stable assembly is guaranteed. The expansion card is held constantly by the mounting element, wherein the mounting element itself can be locked on the module carrier.

We also an arrangement comprising a module with a mounting element and an expansion card of the mentioned type, as well as a module carrier, wherein the mounting element is locked on a retaining element of the module carrier such that the plug of the expansion card held in the mounting element and contacts on a circuit board mounted on the module carrier are fixed relative to each other, wherein the retaining element encompasses the contacts of the circuit board in a frame-like manner.

Through the frame-like arrangement of the retaining element of the module carrier around the plug contacts of the circuit board, the plug connections are fixed in a stable arrangement between the expansion card and the circuit board if the expansion card is fixed on the module carrier with the mounting element. Both the fixing on the module carrier and also the contacting of the expansion card to the circuit board can be performed in one assembly step of the expansion card with the mounting element, wherein the plug contacts of the expansion card are automatically connected and fixed with the contacts of the circuit board when the mounting element locks on the module carrier.

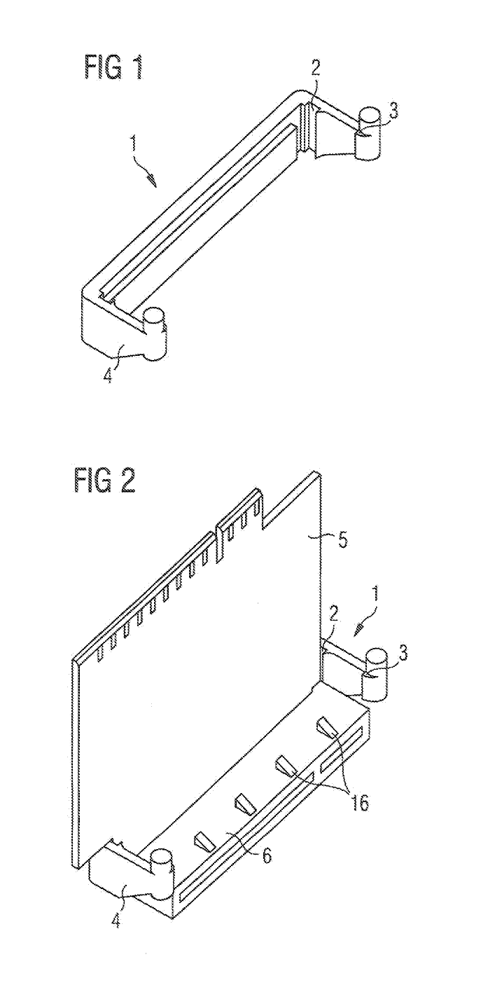

Turning now to the Drawings, FIG. 1 shows a mounting element 1 with two retaining arms 4 arranged on the mounting element 1 such that the mounting element 1 is constructed as a U-shaped retaining bracket. Furthermore, first mounting means 2 are constructed on the mounting element 1 so that an expansion card is held in the mounting element 1 and can be fixed on the first mounting means 2. The first mounting means 2 are here constructed as grooves so that an expansion card can be either pushed from above into the grooves or clicked into the grooves from the front. Advantageously, the retaining arms 4 taper on their inner sides so that a simple clicking of an expansion card from the front occurs. Furthermore, the retaining arms 4 open into second mounting means 3 that are constructed as catch hooks that can be locked onto a retaining element of a module carrier. With the second mounting means 3, the mounting element 1 can therefore be fixed onto a module carrier.

FIG. 2 shows a mounting element 1 according to FIG. 1 in which an expansion card 5 is held and fixed on the first mounting means 2. The mounting element 1 encompasses the expansion card 5 in a bracket-like manner with the retaining arms 4. In this way, the expansion card 5 and the mounting element 1 form a stable module that can be gripped by a user on the retaining arms 4 and can be inserted into a computer system. The expansion card 5 has a plug 6 arranged perpendicular to the circuit board of the expansion card 5 so that the circuit board forms with the plug 6, a kind of “elbow” or “angle piece” for expansion of a circuit board, in particular, a motherboard of a computer system. Furthermore, guide tabs 16 are arranged on the plug 6, wherein these tabs guide the plug 6 on a module carrier when the module is locked on the module carrier to contact with contacts on a circuit board and additionally fix the plug also on the module carrier.

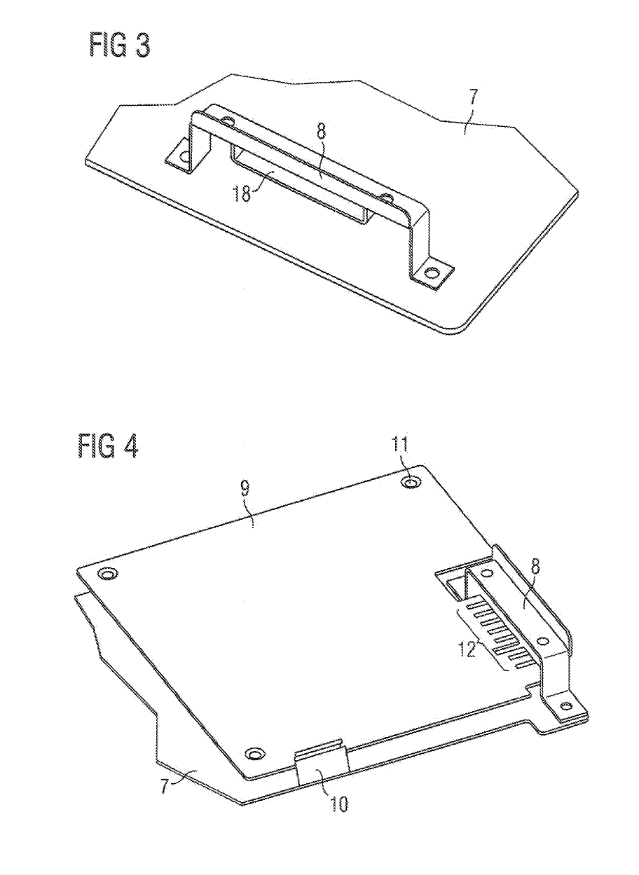

FIG. 3 shows a perspective view of a part of a module carrier 7 on whose top side a frame-shaped retaining element 8 is arranged. The retaining element 8 could be formed, for example, from sheet metal and pressed into the module carrier 7 by means of eyelets or lugs. The retaining element 8 is used for framing contacts of a circuit board (not shown) that can be arranged on the top side of the module carrier 7. The retaining element 8 is further used for locking a module (not shown) consisting of a mounting element 1 and an expansion card 5 according to FIG. 2, wherein the guide tabs 16 on the plug 6 of the expansion card 5 can be guided on the retaining element 8 by means of a holder-shaped or bow-shaped guide element 18, so that the plug 6 of the inserted module can be positioned with a positive fit or from-fit and exactly in the frame-shaped retaining element 8.

FIG. 4 shows a perspective view of a part of a module carrier 7 on the top side of which a circuit board 9 is arranged. The circuit board 9 could be, for example, a motherboard or an IO interface card in a blade server system. The circuit board 9 is fixed on the module carrier 7 with a fixing device 10 and positioned with openings 11 that interact, for example, with bolts (not shown) on the module carrier 7. Furthermore, on the circuit board 9 contacts 12 are arranged that emerge from a frame-shaped retaining element 8 on the module carrier 7. On the retaining element 8, a module with an expansion card 5 and a mounting element 1 can be locked according to FIG. 2, wherein concurrently the contacts 12 of the circuit board 9 are contacted electrically to a plug 6 of the expansion card 5.

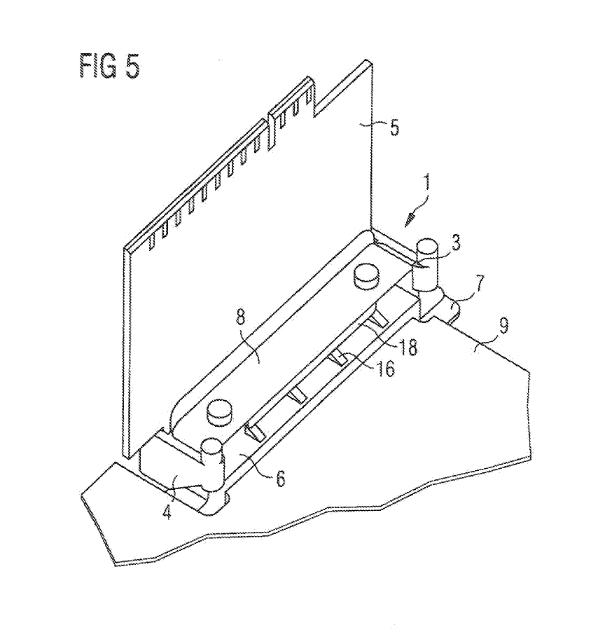

FIG. 5 shows an arrangement of a module consisting of a mounting element 1 and an expansion card 5 with a part of a circuit board 9 that is mounted on a module carrier 7 according to FIG. 4. With its retaining arms 4, the mounting element 1 encompasses the expansion card 5 in a bracket-like manner, with this card 5 being fixed in the mounting element 1. Furthermore, the mounting element 1 is locked on the frame-shaped retaining element 8 of the module carrier 7 with the second mounting means 3. The second mounting means 3 may thus be constructed as catch hooks that snap onto the retaining element 8 and engage behind this element so that the entire module consisting of the expansion card 5 and the mounting element 1 is fixed on the retaining element 8. The plug 6 is guided by its guide tabs 16 on the guide element 18 of the retaining element 8 when the module is inserted such that the plug 6 interacts with contacts 12 of the circuit board 9 according to FIG. 4. The contacts 12 are pushed into the plug 6 and establish an electrical connection between the circuit board 9 and the expansion card 5. With the mounting element 1, an expansion card 5 can therefore be fixed in a single assembly step on a module carrier 7 of a computer system and simultaneously electrically connected at its plug 6 to contacts of a circuit board 9. The module can be gripped at the retaining arms 4 and locked on the module carrier by pressing on the mounting element 1 with the second mounting means 3. Solder pins arranged on the side facing away from the plug 6 of the expansion card 5 are covered by the mounting element 1 so that there is no risk of damaging these pins during assembly of the expansion card 5. To detach the mechanical and electrical connection between the module and the circuit board 9 or the module carrier 7, the retaining arms 4 can be pushed laterally outward by a user so that the catch hooks of the second mounting means 3 are detached from engagement behind the retaining element 8. The module can then be pressed away from the circuit board 9 and removed completely from the module carrier 7 and the circuit board 9. A crucial factor here is that the module remain a closed unit, so that the expansion card 5 is further fixed in the mounting element 1 also when the module is detached. The mounting element 1 is thus connected captively to the expansion card 5.

In other, not shown configurations/examples, a mounting element 1 can also be designed to hold two or more expansion cards 5 that can be fixed by several first mounting means 2 on the mounting element 1 and can be fixed with several second mounting means 3 of the mounting element 1 on retaining elements 8 of a module carrier 7. Furthermore, it is possible to hold, in a mounting element 1, an expansion card 5 that has, instead of a plug 6, contact tongues or studs for interacting with a plug on a circuit board 9. A mounting element 1 is to be constructed such that it completely encloses an expansion card 5 so that the expansion card 5 can be placed onto the circuit board 9, for example, from above, wherein the contact tongues of the expansion card 5 engage in the plug of the circuit board 9 and the entire module locks onto the module carrier. The expansion card can be a riser card of the type described above, but also any other expansion card for computer systems, such as, for example, a network or graphics card. Also, the constructions of all of the mounting means, catch elements, contact tongues, and plugs, as well as retaining and guide elements of a module carrier, are here selected merely as examples.

1. A mounting element for an expansion card in a computer system comprising a bracket construction and at least two retaining arms that at least partially encompass an expansion card held in the mounting element, wherein the mounting element can be locked on a retaining element of a module carrier, and the mounting element has a first mount designed to fix an expansion card held in the mounting element substantially perpendicular to the retaining arms such that the mounting element is connected captively to the expansion card.

2. The mounting element according to claim 1, wherein the first mount is constructed as grooves into which an expansion card can be fixed.

3. The mounting element according to claim 1, further comprising a second mount that locks the mounting element on a retaining element of a module carrier arranged on the retaining arms.

4. The mounting element according to claim 3, wherein the second mount is constructed as catch hooks that engage behind a retaining element of a module carrier in a locked state of the mounting element.

5. A system comprising a mounting element according to claim 1, and an expansion card having a plug that interacts with contacts on a circuit board, wherein the plug is arranged perpendicularly to a circuit board of the expansion card and wherein the expansion card is encompassed by the mounting element on a side facing away from the plug and is fixed on the mounting element.

6. A system comprising a module with a mounting element, an expansion card according to claim 5, and a module carrier, wherein the mounting element is locked on a retaining element of the module carrier such that the plug of the expansion card held in the mounting element and the contacts of a circuit board mounted on the module carrier are fixed relative to each other, wherein the retaining element surrounds the contacts of the circuit board in a frame manner.

7. A computer system comprising an arrangement according to claim 6, wherein the computer system is a blade server.

8. The mounting element according to claim 2, further comprising a second mount that locks the mounting element on a retaining element of a module carrier arranged on the retaining arms.

9. A system comprising a mounting element according to claim 2, and an expansion card having a plug that interacts with contacts on a circuit board, wherein the plug is arranged perpendicularly to a circuit board of the expansion card and wherein the expansion card is encompassed by the mounting element on a side facing away from the plug and is fixed on the mounting element.

10. A system comprising a mounting element according to claim 3, and an expansion card having a plug that interacts with contacts on a circuit board, wherein the plug is arranged perpendicularly to a circuit board of the expansion card and wherein the expansion card is encompassed by the mounting element on a side facing away from the plug and is fixed on the mounting element.

11. A system comprising a mounting element according to claim 4, and an expansion card having a plug that interacts with contacts on a circuit board, wherein the plug is arranged perpendicularly to a circuit board of the expansion card and wherein the expansion card is encompassed by the mounting element on a side facing away from the plug and is fixed on the mounting element.
